(19) United States
(12) Patent Application Publication
(10) Pub. No.: US 2020/0028739 A1
(43) Pub. Date: Jan. 23, 2020

(54) METHOD AND APPARATUS FOR CLOSED-LOOP AND DYNAMIC CAPACITY MANAGEMENT IN A WEB-SCALE DATA CENTER

(71) Applicant: Nutanix, Inc., San Jose, CA (US)

(72) Inventors: Nagesh Soma SHEKAR, Bangalore (IN); Subash ATREYA, San Mateo, CA (US); Jeremy Steven LAUNIER, Sunnyvale, CA (US); Rohit THUKRAL, San Jose, CA (US); Parmeet Singh CHADDHA, Saratoga, CA (US)

(73) Assignee: Nutanix, Inc., San Jose, CA (US)

(21) Appl. No.: 15/492,917

(22) Filed: Apr. 20, 2017

Related U.S. Application Data
(60) Provisional application No. 62/445,232, filed on Jan. 11, 2017.

(51) Int. Cl. H04L 12/24

(52) U.S. Cl. CPC H04L 41/0803; H04L 67/1097; H04L 41/14

(57) ABSTRACT

A system for implementing closed-loop and dynamic capacity management in a web-scale data center is provided. In some embodiments, the method includes a local feedback loop for local system data collection and reconfiguration process that is responsive to inputs received from a global sizing system, where the global sizing system maintains local system data collected at a plurality of systems and transferred to the global sizing system using a data collection feedback mechanism. In some embodiments, the global sizing system manages a set of data representing best practices, and performs data analysis on the local system data collected at a plurality of systems in order to determine if there are any updates to the dataset for the best practices data. Finally, the global sizing system transmits the best practices data to the local system for analysis of the local systems based on the best practices data.

### CROSS REFERENCE TO RELATED APPLICATIONS

The present application claims the benefit of priority to co-pending U.S. Provisional Patent Application No. 62/445,232, filed on Jan. 11, 2017, entitled “METHOD AND APPARATUS FOR CLOSED-LOOP AND DYNAMIC CAPACITY MANAGEMENT IN A WEB-SCALE DATA CENTER”, and is related to U.S. Pat. No. 8,601,473, issued on Dec. 3, 2013, entitled “ARCHITECTURE FOR MANAGING I/O AND STORAGE FOR A VIRTUALIZATION ENVIRONMENT”, U.S. patent application Ser. No. 15/006,416, filed Jan. 26, 2016, entitled “ARCHITECTURE FOR IMPLEMENTING CENTRALIZED MANAGEMENT FOR A COMPUTING ENVIRONMENT”, and U.S. patent application Ser. No. 15/298,107, filed Oct. 19, 2016, entitled “METHOD AND APPARATUS FOR DECLARATIVE DEFINITION OF INFRASTRUCTURE COMPONENTS, SOFTWARE, WORKLOADS, AND SIZING RULES FOR SIZING SYSTEM”, which are hereby incorporated by reference in their entirety.

### FIELD

This disclosure concerns a method and apparatus for closed-loop and dynamic capacity management in a web-scale data center.

### BACKGROUND

The cost of purchasing and maintaining servers and technological equipment can represent a significant drain on the resources of a company and substantially affect their bottom line. Furthermore, for companies that are in the business of providing computing to others as a service, the difference between a well-managed computing infrastructure and a poorly managed computing infrastructure can be the difference between a profitable enterprise and a failed enterprise. Additionally, within many organizations computing systems and infrastructure can represent a significant expenditure, and therefore any possible cost savings may be important to the success of the entity.

Traditionally, capacity management is based on one-way communication of data from client systems to a centralized system that collects the data for offline analysis. However, offline data analysis and capacity management suffers from some inherent limitations. First, offline capacity management processes suffer from delays when accounting for changes, which may result in a significant amount of time passing before any recommended changes can take effect. This often leading to reservations of excess capacity in order to account for peak or bursty demand. Furthermore, offline capacity management often leads to siloed reservation of capacity dedicated to particular tasks in order to ensure that each task has sufficient resources to run smoothly. Unfortunately, this also increases the reservation of extra capacity and therefore contributes to sub-optimal use of reserved capacity when the peak or bursty demand has passed.

Therefore, what is needed is an improved method for closed-loop and dynamic capacity management in a web-scale data center.

### SUMMARY

The present disclosure provides a method and apparatus for closed-loop and dynamic capacity management in a web-scale data center.

In some embodiments, the method includes a local system data collection and reconfiguration process that is responsive to inputs received from a global sizing system.

In some embodiments, the method includes a local feedback loop for local system data collection and a reconfiguration process that is responsive to inputs received from a global sizing system, where the global sizing system maintains local system data collected at a plurality of systems and the collected data is transferred to the global sizing system using a data collection feedback mechanism. Additionally, in some embodiments the global sizing system manages a set of data representing best practices and performs data analysis on the local system data collected at a plurality of systems in order to determine if any updates should be made to the dataset corresponding to the best practices.

In some embodiments, the process may begin at an initial sizing stage before the target system is deployed, where the initial sizing stage generates a system specification that may be used for deployment. Additionally, in some embodiments the system may wait for deployment before requesting usage data.

In some embodiments, the initial sizing stage includes at least receiving an initial set of system workload and preference information at a global sizing system, analyzing the received information to generate one or more system configurations that would be suitable for performing the indicated functions, and generating a deployment specification for at least one system configuration.

In some embodiments, the data collection loop corresponds to receiving system usage and configuration information from a target system at a global sizing system or feedback management module, associating the received information with an initial configuration, and storing the received information in appropriate physical or logical structures. In some embodiments, the process is repeated for any number of target systems. For example, a feedback management module may transmit a request to each system of a plurality of systems that have a corresponding an entry in a database of deployed systems (e.g. a list of deployed systems) for system usage and configuration information. In the alternative, each system could transmit system usage and configuration information to the feedback management module upon the occurrence of any relevant event, periodically, or any combination thereof.

In some embodiments, analysis of the best practices could be predicated on one or more conditions, such as a minimum or maximum time since the last time analysis of the best practices was performed, whether new data has been received, or any other relevant condition or combination of conditions.

In some embodiments, best practices analysis comprises generating aggregated comparison data. The aggregated comparison data may comprise data aggregated on a per user basis, per function basis, per resource basis, per component basis, any combination thereof, or in any form that may be useful in determining the actual/relative usage of a resource compared to its expected usage. Furthermore, in some embodiments the aggregated comparison data may be compared to a set of data representing current best practices in order to determine if any adjustments should be made to that data, and if so to make those adjustments.

In some embodiments, the adjusted best practices data may be pushed or otherwise transmitted to one or more target systems by the global sizing system. The target systems may then trigger analysis of the respective target system using the updated best practices and may generated reconfiguration information which may be acted upon either before returning to or during normal operation. For example, the updated best practices may indicate that deduplication is recommended for internal email systems. Whereas previous best practices did not indicate that deduplication was recommended. As a result, a local sizing system may, upon analysis, automatically change the system settings to enable deduplication. In another example, the generated recommendation may include hardware changes, such as the adding extra storage or the reconfiguration of one or more nodes from a first system for use in a second system where an individual entity (e.g. company) has more than one system.

Further details of aspects, objects, and advantages of the disclosure are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1 illustrates an approach including a feedback loop between a global sizing system and a plurality of remote systems in which some embodiments are implemented.

FIG. 2 illustrates a flowchart of the operation of the feedback loop between a global sizing system and a plurality of remote systems in which some embodiments are implemented.

FIG. 3 illustrates a flowchart of the initial sizing stage in accordance with some embodiments.

FIG. 4 illustrates a flowchart of the operation of the data collection stage, the data analysis stage, and the update best practices stage in accordance with some embodiments.

FIG. 5 illustrates a flowchart of the operation of the local system data collection and reconfiguration process in accordance with some embodiments.

FIG. 6A illustrates a virtualized controller as implemented by the shown virtual machine architecture in which some embodiments are implemented.

FIG. 6B illustrates a virtualized controller implemented by a containerized architecture in which some embodiments are implemented.

FIG. 7 illustrates a system to implement a virtualization management console according to some embodiments of the invention.

FIG. 8 illustrates a computing environment having multiple underlying systems/clusters to be managed, where a separate management node exists for each of the underlying systems/clusters.

FIG. 9 is a block diagram of an illustrative computing system suitable for implementing an embodiment of the present invention.

### DETAILED DESCRIPTION OF THE EMBODIMENTS OF THE INVENTION

The present disclosure provides a method and apparatus for closed-loop and dynamic capacity management in a web-scale data center.

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material or characteristic described in connection with the embodiments is included in at least one embodiment. Thus, the appearances of the phrase “in some embodiments” or “in other embodiments”, in various places throughout this specification are not necessarily referring to the same embodiment.

It is noted that the description generally discusses the disclosure as relevant to system administrators. However, the present disclosure is not limited to system administrators. Instead, the present disclosure is applicable to any user that desires to utilize any of the disclosed material contained herein.

The invention provides the ability to implement closed-loop and dynamic capacity management in a web-scale data center. To illustrate the embodiments of the invention, various embodiments will be described in the context of a virtualization environments. It is noted, however, that the invention is applicable to other types of systems as well, and is therefore not limited to virtualization environments unless explicitly claimed as such. Indeed, the invention is applicable to any distributed system capable of implementing closed-loop and dynamic capacity management in a web-scale data center.

By way of background, a “virtual machine” or a “VM” refers to a specific software-based implementation of a machine in a virtualization environment, in which the hardware resources of a real computer (e.g., CPU, memory, etc.) are virtualized or transformed into the underlying support for the fully functional virtual machine that can run its own operating system and applications on the underlying physical resources just like a real computer. Virtualization works by inserting a thin layer of software directly on the computer hardware or on a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows multiple virtual machines to run on a single physical machine, with each virtual machine sharing the resources of that one physical computer across multiple environments. Different virtual machines can run different operating systems and multiple applications on the same physical computer. One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Virtualization systems have now become a relatively common type of technology used in many company and organizational data centers, with ever increasing and advancing capabilities being provided for users of the system. However, the ability of users to manage these virtualizations systems have thus far not kept up with the rapid advances made to the underlying systems themselves.

As noted above, one area where this issue is particularly noticeable and problematic is with respect to the desire to more efficiently provision and manage these systems. Therefore, what is described is a process for closed-loop and dynamic capacity management in a web-scale data center.

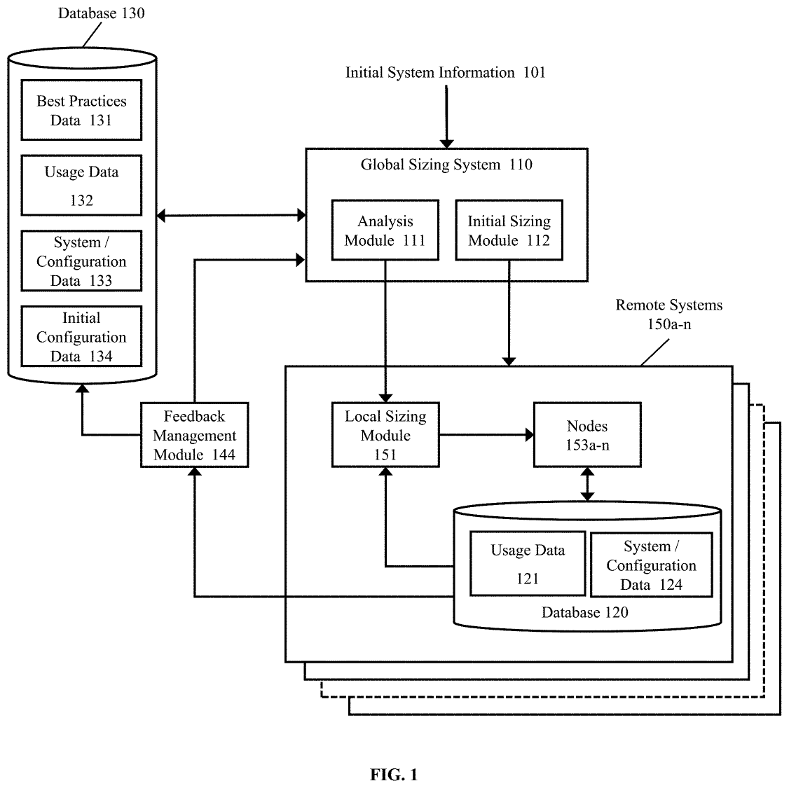

FIG. 1 illustrates an approach including a feedback loop between a global sizing system and a plurality of remote systems in which some embodiments are implemented. This approach uses a feedback loop between a global sizing system and a plurality of remote systems to improve management from a sizing perspective for computing infrastructure. Specifically, a remote system can be configured using the global sizing system and tracked through its lifetime to determine whether or not the system was originally sized according to a given set of rules and whether those sizing rules need to be adjusted based on the data. In some embodiments, if an initial configuration is not identified a current or earliest known configuration may be used as an initial configuration.

The global sizing system 110 includes an initial sizing module 112. This initial sizing module can be used to determine the components and configuration of a system based on a set of specified needs. For instance, an internal customer relations management system (CRM) sized to support a specified number of employees might have an initial configuration comprising some number of nodes 153a-n and an associated database 120. Such a system can be deployed as a remote system of remote systems 150a-n.

Remote systems 150a-n might each comprise a respective set of nodes 153a-n, a database 120 which includes a first collection of storage for usage data 121 and system configuration data 124 as well as any other necessary data. Each of the remote systems 150a-n may periodically provide usage data and configuration information back to the global sizing system 110 via a feedback management module 144 which manages the storage of data into database 130, which may in turn be analyzed to determine whether any changes should be made to the best practices data 131 for sizing any current or future remote system.

The initial sizing module 112 comprises software, hardware, or some combination thereof for providing a sizing system. The initial sizing module 112 receives a series of inputs describing one or more desired use cases (e.g. functions) from an administrator or another user at 101. For instance, an individual at a company wishing to create an internal email system, inventory management system, and webserver might enter those functions and a corresponding estimated of the number of users for each, such as a minimum or maximum number of users for each of the given functions. This provided information corresponds to initial system information 101, which includes at least information that can be utilized to size an initial system for a given purpose or purposes. Based on the received initial system information and the data already in the database 130 the initial sizing module 112 will generate a recommended set of components and their configurations including any necessary software. This information is provided to the administrator/user/customer to enable them to deploy the system and may be stored in the database 130 as initial configuration data 134.

Once the system is deployed as a remote system of remote systems 150a-n the system will have various settings configured either manually or automatically. For example, configuration could be performed manually using a deployment specification. However, in the alternative the system could be automatically configured using the local sizing module 151. The local sizing module 151 provides a subset of the functionality of the global sizing system—e.g. could be used to enforce the best practices or initial configuration to the extent such information is received, either directly or indirectly, from the global sizing system 110. The nodes 153a-n will be discussed in more detail below. Briefly, nodes generally comprise a processor, memory, storage, and communications interfaces. Furthermore, the nodes themselves may comprise storage components that are aggregated together using logical processes to generate a database constructed from the distributed storage of the nodes 153a-n, such as database 120 which is represented as a single logical storage structure.

Database 120 may provide the necessary storage for the normal operation of remote system. However, two types of data are particularly relevant here, usage data 121 and system/configuration data 124. Usage data 121 comprises performance data for the remote system. Performance data corresponds to the different resources of the system and may comprise anything from relative numbers such as percentages of utilization to absolute numbers, such as amounts a resource utilized or available. System/configuration data 124 quantifies the system and includes at least information corresponding to the system's software components, hardware components, and the systems connections and how these components and connections are arranged.

The feedback management module 144 periodically receives the usage data 121 and system/configuration data 124 from remote systems 150a-n, and stores the received data in the appropriate areas of the database 130. For instance, initial configuration data may be stored at the time that the initial configuration is generated but before the system is deployed. For instance, an initial configuration dataset may be stored in the initial configuration data 134 even if the data was not already present. Furthermore, it is likely that many initial configurations are generated that are not ultimately deploy therefore, initial configurations may be scrubbed periodically when they are not also verified as having been deployed after a specified amount of time. Additional information may be stored in the system/configuration data 133, where changes or deviations from the initial configuration are stored, and potentially where changes in system function are noted, e.g. a system initially sized to support 50 users has now been configured to support 100 users or where an additional function is added such as support for a company's accounting department and including accounting software, e.g. QuickBooks. Furthermore, the feedback management module 144 may store usage data 121 pertaining to individual systems in the database 130 as usage data 132. In this way the feedback management module 144 may collect data for tracking a plurality of remote systems and for use by the global sizing system in evaluating best practices data 131. In some embodiments, a system that is otherwise unidentified as a preexisting configuration may be categorized and corresponding information may be stored in the appropriate location using the current information as the initial configuration information.

The analysis module 111 may receive notification from the feedback management module 144 of updated usage data or may periodically check database 130 for updated data. The analysis module 111 may then process the usage data using any known methods for data processing to determine relevant characteristics. For example, the analysis module 111 may process the data corresponding to internal emails systems and determine that on average each user is sending or receiving more emails than expected and using more data storage than expected. As a result, the analysis module 111 may adjust the best practices data 131 to reflect the increase in emails and data, such as by specifying more processing power per user and by specifying more storage per users. Such analysis techniques may also comprise statistical analysis as is known in the art. For example, determining ranges for data, determining and excluding data that is representative of statistical outliers, and any determination of any appropriate ranges or standard deviations from a mean in determining what is considered to be normal usage of resources. Furthermore, the analysis module may push this and other updated guidelines to the local sizing module 151 of the remote systems 150a-n.

The local sizing module 151 can, in turn, analyze the remote system to determine if the system meets the best practices guidelines, and notify the system administrator of any recommended changes. Furthermore, not all recommendations require additional or different hardware or even software. For instance, a configuration may be considered within best practices guidelines, except to the extent that the system fails to have enable compression. In such case, the local sizing module 151 may, depending on the systems settings, enable compression or notify the administrator that it is recommended to enable compression. Finally, in some embodiments the local sizing module can serve to adjust for incorrect human interpretations, such as where a reported function is inaccurately reported in the system/configuration data 124 when compared with the actual usage data 121. This may be accomplished by generating reports for reported versus actual functions and by notifying the administrator of any discrepancies.

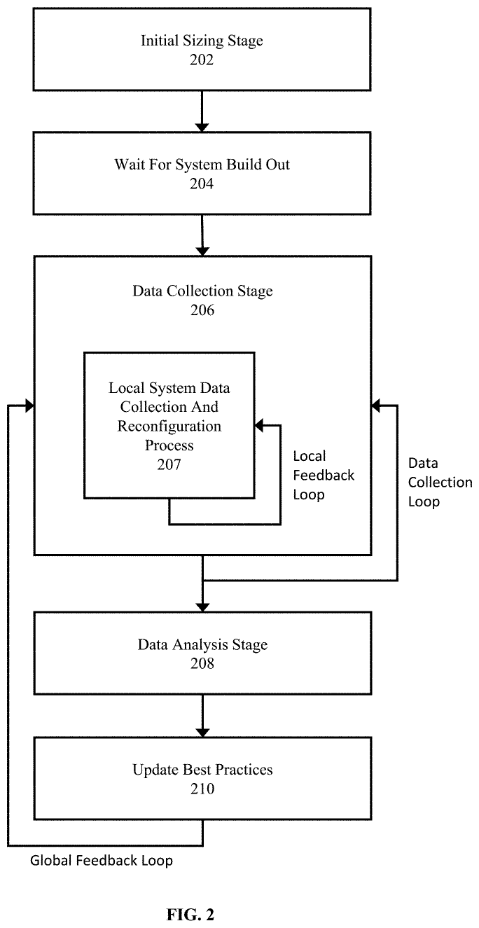

FIG. 2 illustrates a flowchart of the operation of the feedback loop between a global sizing system and a plurality of remote systems in which some embodiments are implemented. In fact, the illustrated system has three loops, an innermost loop for performing local feedback, a middle loop for performing data collection, and an outer loop for global feedback. However, the process normally starts with an initial sizing stage.

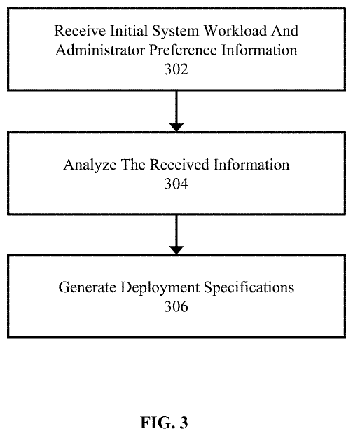

The initial sizing stage 202 corresponds to the process for determining the specifications for the system (target system) before the system itself actually exists. This will be discussed further in FIG. 3 and the associated text. However, briefly the initial sizing stage comprising receiving initial workload information for the target system and determining its parameters based on best practices data in order to generate a deployment specification.

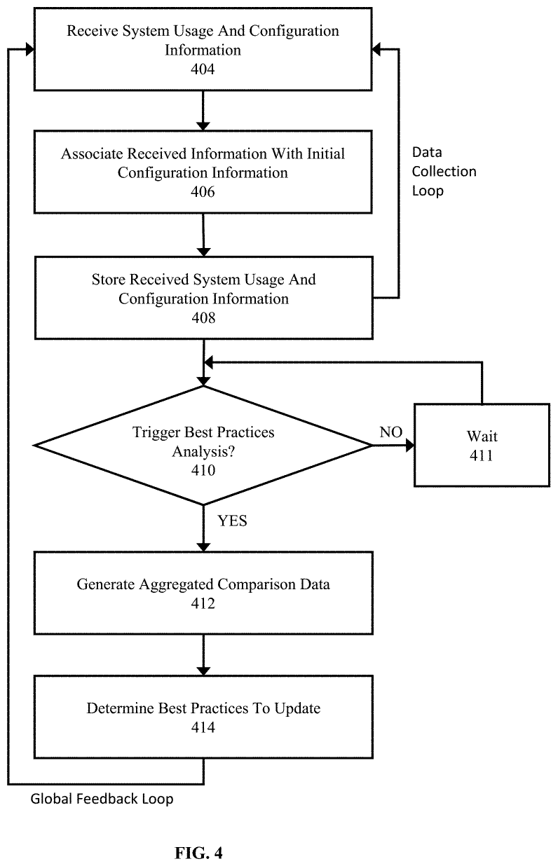

Once the initial sizing stage 202 is completed the global sizing system 110 waits for the deployment specification to result in a target system. In other words, the global sizing system 110 waits for system build out 204 to occur so that the normal functions and data collection and processing can occur. However, in most cases the global sizing system 110 will be in operation with respect to a set of other systems that have already been deployed, and it is only with respect to that particular target system that the global sizing system 110 is waiting for deployment. Regardless, the process continues with the data collection stage 206, the local system data collection and reconfiguration process 207, the local feedback loop, the data collection loop, data analysis at 208, updating of best practices data at 210, and finally repeating the process at the global feedback loop. All of which are discussed in more detail in FIG. 4, the associated text, and addressed briefly here.

The data collection stage 206 corresponds to the normal operation of the target system and to other previously existing systems. During this stage information is collected pertaining to usage and utilization of the remote systems, such as processing, communications, and storage utilization and to reliability data, e.g., crash reporting and other failures of programs to operate as intended. This data is then periodically transmitted to the global sizing system 110 for analysis with other usage data as represented by the data collection loop.

The data itself may be collected at the local system level at a respective local system data collection and reconfiguration process 207 (local process). The local process serves at least two purposes. First, to provide the data to the global sizing system 110 such that the data collected can be used in analysis with other data similarly collected from other systems. Second, for monitoring the system locally wherein the initial or current configuration is compared to a set of best practices received from the global sizing system 110 in order to determine the functioning of the system and to analyze the system for over or under provisioning and for other configuration problems that are contrary to those in the received best practices data.

The data analysis stage 208 may be triggered by any number of conditions, such as a specified time interval, upon the receipt of new data, upon some threshold amount of received data, or any combination thereof. Briefly, this stage comprises analyzing the received data to determine if the recommend configuration information (best practices) properly corresponds to actual usage information. If the data analysis determines that a change is appropriate, then the process continues at 210 where the best practices data is updated and the process returns to the data collection stage as indicated by the global feedback loop.

FIG. 3 illustrates a flowchart of the initial sizing stage in accordance with some embodiments.

The initial sizing stage comprises three separate steps. First, initial system workload and administrator preference information is received at 302. Then the provided information is applied to best practices data to determine a recommended configuration at 304, and finally generating a deployment specification at 306.

At 302 the initial system workload and administrator preference information is received at the global sizing system 110. There are two reasons for this, first the target system does not normally exist, and so there is generally no target system with which to generate a deployment specification. Second, because the global sizing system 110 maintains the best practices data that is to be used for generating any possible solutions and deployment specifications. The initial system workload information corresponds to functions that the system is to support e.g., general clerical, data entry, email, web browsing, CRM access, inventory management, website host, etc. Whereas administrator preferences correspond to administrator specified information that does not directly correspond to a function, e.g. brand preferences, uptime requirements, minimum available resource thresholds, interface restrictions, software restrictions, volume ranges, cooling requirement restrictions, power restrictions, etc. In this way the administrator can specify both the functions and the parameters within which those solutions must fall.

The initial sizing module may then use the best practices data to analyze the received information at 304. Depending on available options and user preferences the analysis may result in one or many possible solutions, over which the administrator may be given control to filter and apply additional rules and to return to 302 for reanalysis if necessary. However, eventually the process results in the selection of a specific configuration and a generation of a deployment specification at 306 which may be provided to the user.

FIG. 4 illustrates a flowchart of the operation of the data collection stage, the data analysis stage, and the update best practices stage in accordance with some embodiments. Specifically, FIG. 4 provides additional details of the operation of the global sizing system 110 and the feedback management module 144 in accordance with some embodiments.

The process starts at 404 where the feedback management module 144 receives system usage and configuration information as discussed previously as being collected at the local system level and periodically transmitted to the global sizing system 110. Such information could be collected via polling of the remote systems, or automatically transmitted by the remote systems at scheduled intervals or upon occurrence of any relevant event, such as prior to any system update or upon the occurrence of a system error.

Once the information is received the feedback management module 144 will then attempt to associate the received information with initial configuration information already stored in database 130 at 406. The association of the information can be performed in various ways. For instance, matching the actual configuration to an initial configuration already stored in the database using a user ID, customer ID, serial number, product key, or any other unique or semi unique information. Once the received information is matched to an existing set of data associated with the system the received usage and configuration information may be store in the appropriate sections of database 130. And the process can be repeated for multiple systems via the data collection loop. In some embodiments, if no system identification is made to a preexisting initial configuration, then one or more new entries can be made as appropriate in order to identify the system the next time information is received before storing the received usage and configuration information.

Furthermore, the storing of received system usage and configuration information at 408 may result in a determination at 410 as to whether to trigger analysis of the best practices data. Such analysis is generally computationally intensive, and increases with the number of systems tracked and the time and frequency over which those systems are tracked. As such, best practices analysis may be predicated on a determination that one or more conditions are met before the performing the actual analysis with respect to the received usage data. For instance, analysis could be triggered when new data has been received, when a minimum amount of time has passed, when the global sizing system 110 is below a utilization or load threshold, when a minimum specified amount of time has passed since a previously triggered analysis has completed or been initiated, or any combination thereof If the best practices analysis is not triggered at 410 then the process proceeds to 411 where an amount of time passes before returning to 410 to make another determination as to whether best practices analysis should be performed.

If it is determined at 410 that the best practices analysis should be performed, then the process continues at 412 where the received information from multiple systems may be used to generate aggregated comparison data. Aggregated comparison data may be generated for any number of combinations. For instance, data may be aggregated on a per user basis, on a per function basis, on a per resource basis, on a per component basis, or on any combinations thereof, or in any form that may be useful in determining the actual/relative usage of a resource compared to its expected usage.

Once the data is aggregated into different sets corresponding to functions or resources or both, it may be analyzed to determine if the actual data is in line with the best practices data or if the best practices data needs to be updated at 414. Such updates may be predicated on various conditions, such as a minimum deviation, a maximum deviation, consistency of deviations over a period of time, or variability between user systems tracked. Furthermore, the updates may be performed in a complete or incremental manner, such that the best practices data does not suffer from unnecessary variation or from unwanted short term seasonal effects. Finally, the process may distribute best practices data to a target system and other tracked systems for local processing via the global feedback loop before receiving additional system usage and configuration information.

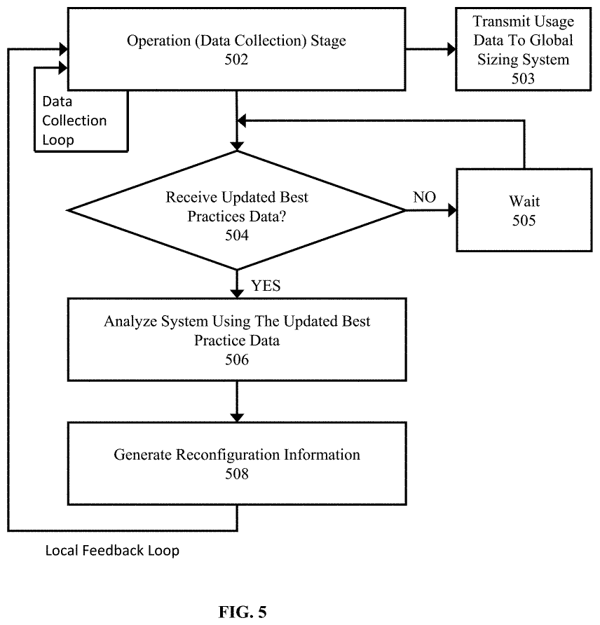

FIG. 5 illustrates a flowchart of the operation of the local system data collection and reconfiguration process in accordance with some embodiments. This process generally provides for collection of data and for analyzing the local system and generating reconfiguration information in response when appropriate.

The process begins at 502 when a target system is deployed and the operation (data collection) stage is entered. This stage comprises a normal operating mode for the system with any number of available functions taking place, and where system information and data is collected. The data collected may include the minimum/maximum/average number of users for any given function or functions over a period of time. Similarly, data may be collected that represents the minimum/maximum/average utilization of system resources over time (e.g. processing power, storage space, temporary memory, communications bandwidth, etc.). Finally, the data may be collected at differing intervals. For example, data could be collected at some number of seconds, minutes, hours, days, weeks, etc. Furthermore, data could be collected using other compression or smoothing techniques, e.g. running averages recorded at one or more intervals, recording only minimum/maximum/average values for given time ranges, recording representative data (e.g. using a single entry to represent a range of values), or any combination thereof. The information itself may be collected based on any number of factors, such as based on intervals, on overall usage, on the occurrence of various events, or some combination thereof. This process is ongoing as represented by the data collection loop which returns the data collection stage to data collecting while the system is operating normally.

In some embodiments, the data collection stage may trigger the transmission of the collected usage data to a global sizing system at 503. As discussed previously, transmission of the collected data may be triggered by any number of factors and at any interval or even randomly. The transmission may be trigger either locally or in response to receipt of a request for usage/configuration information from a global sizing system or feedback management module associated with the global sizing system. Finally, data may be transmitted while additional data is being collected. For example, during normal operation of the local system and upon receipt of a request for usage/configuration information the local system could transmit data collected prior to the receipt of the request. Furthermore, the data could include all usage/configuration information the local system has collected or a subset of the usage/configuration information collected, such as the information collected after previous request was serviced.

Furthermore, in order to address any changing recommendations (as represented by the best practices data) or usage during the data collection stage the local system may periodically trigger a determination as to whether any updated best practices data has been received at 504. While the process is illustrated here as being dependent upon receipt of updated best practices data other information could be used to trigger analysis. For example, analysis may be performed periodically, randomly, when system utilization drops below a specified threshold, based on other usage information such as provisioning of additional accounts or in response to the occurrence of a specified usage threshold being met, or some combination thereof.

As illustrated, if no updated best practices data is received at 504 the process may continue at 505 where a period of time passes before the system attempts to make the determination at 504 again. However, if it is determined that updated best practices information has been received then the process continues at 506, where the system is analyzed using the local sizing module 151 to determine if the current system configuration is within the recommended values or ranges as dictated by the updated best practices data. This can be performed by first determining the current system configuration, the functions supported by the system, and the number of users that the system supports for each respective function, second generating results using the same functions and the number of users for each respective function at a local sizer, and third comparing the first results to second results. In the alternative, current system can be can be compared to the best practice data that corresponds to the first results in order to determine whether the current configuration meets a base configuration level through various computations/determinations, e.g. falls within the bounds of a requirements specification.

When there is a mismatch between the system and the best practices data reconfiguration information can be generated at 508. The reconfiguration information may be implemented manually or in some cases may be implemented automatically. For example, the installation of additional or replacement hard drives into one or more nodes would generally have to be done manually. However, a configuration change such as a modification to a setting, e.g. enabling or disabling deduplication, may be done automatically provided the administrator has enabled such a feature in the system settings. However, regardless of what the actual change is, the system returns to the normal operation (data collection) stage at 502 via the feedback loop where any configuration changes may be logged and data collection continues.

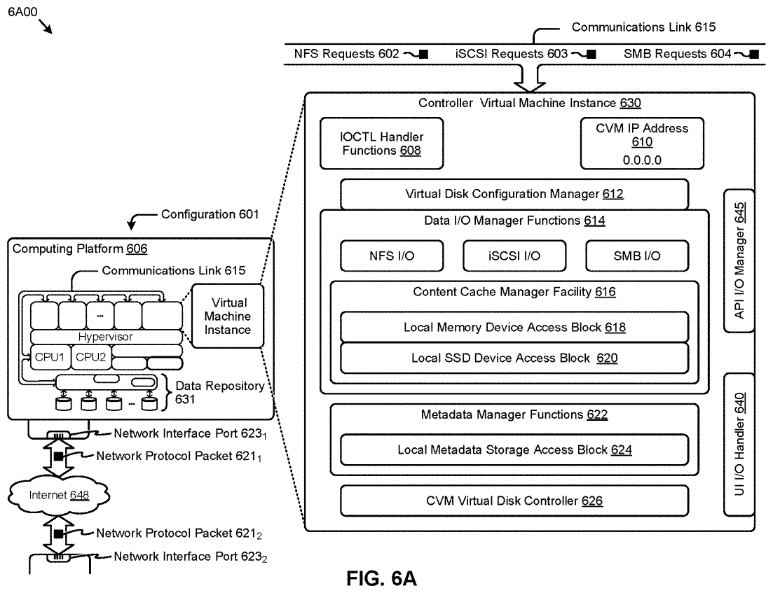

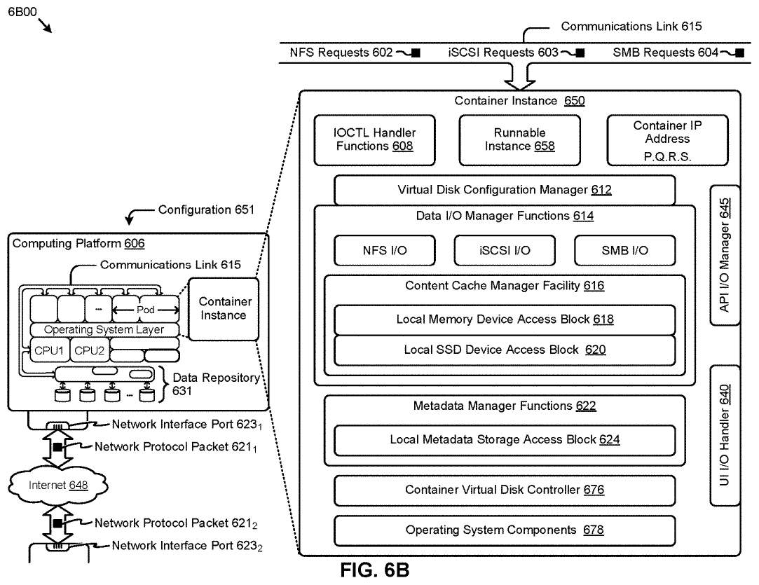

FIG. 6A illustrates a virtualized controller as implemented by the shown virtual machine architecture in which some embodiments are implemented. FIG. 6A depicts a virtualized controller as implemented by the shown virtual machine architecture 6A00. The heretofore-disclosed embodiments including variations of any virtualized controllers can be implemented in distributed systems where a plurality of networked-connected devices communicate and coordinate actions using inter-component messaging. Distributed systems are systems of interconnected components that are designed for or dedicated to storage operations as well as being designed for, or dedicated to, computing and/or networking operations. Interconnected components in a distributed system can operate cooperatively so as to serve a particular objective, such as to provide high-performance computing, high-performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyper converged system coordinates efficient use of compute and storage resources by and between the components of the distributed system. Adding a hyper converged unit to a hyper converged system expands the system in multiple dimensions. As an example, adding a hyper converged unit to a hyper converged system can expand in the dimension of storage capacity while concurrently expanding in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyper converged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyper converged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as containers. In some systems and/or environments, hypervisor-assisted virtualization techniques and operating system virtualization techniques are combined.

As shown, the virtual machine architecture 6A00 comprises a collection of interconnected components suitable for implementing embodiments of the present disclosure and/or for use in the herein-described environments. Moreover, the shown virtual machine architecture 6A00 includes a virtual machine instance in a configuration 601 that is further described as pertaining to the controller virtual machine instance 630. A controller virtual machine instance receives block I/O (input/output or IO) storage requests as network file system (NFS) requests in the form of NFS requests 602, and/or internet small computer storage interface (iSCSI) block IO requests in the form of iSCSI requests 603, and/or Samba file system (SMB) requests in the form of SMB requests 604. The controller virtual machine (CVM) instance publishes and responds to an internet protocol (IP) address (e.g., CVM IP address 610). Various forms of input and output (I/O or IO) can be handled by one or more IO control handler functions (e.g., IOCTL functions 608) that interface to other functions such as data IO manager functions 614 and/or metadata manager functions 622. As shown, the data IO manager functions can include communication with a virtual disk configuration manager 612 and/or can include direct or indirect communication with any of various block IO functions (e.g., NFS IO, iSCSI IO, SMB IO, etc.).

In addition to block IO functions, the configuration 601 supports IO of any form (e.g., block IO, streaming IO, packet-based IO, HTTP traffic, etc.) through either or both of a user interface (UI) handler such as UI IO handler 640 and/or through any of a range of application programming interfaces (APIs), possibly through the shown API IO manager 645.

The communications link 615 can be configured to transmit (e.g., send, receive, signal, etc.) any types of communications packets comprising any organization of data items. The data items can comprise payload data, a destination address (e.g., a destination IP address), and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. Additionally, the payload may comprise a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 630 includes a content cache manager facility 616 that accesses storage locations, possibly including local dynamic random access memory (DRAM) (e.g., through the local memory device access block 618) and/or possibly including accesses to local solid state storage (e.g., through local SSD device access block 620).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 631, which in turn can be formatted into any one or more storage areas, and which can comprise parameterized storage accessible by a key (e.g., a filename, a table name, a block address, an offset address, etc.). An external data repository 631 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 624. The external data repository 631 can be configured using a CVM virtual disk controller 626, which can in turn manage any number or any configuration of virtual disks.

Execution of the sequences of instructions to practice certain embodiments of the disclosure are performed by a one or more instances of a software instruction processor, or a processing element such as a data processor, or such as a central processing unit (e.g., CPU1, CPU2). According to certain embodiments of the disclosure, two or more instances of a configuration 601 can be coupled by a communications link 615 (e.g., backplane, LAN, PSTN, wired or wireless network, etc.) and each instance may perform respective portions of sequences of instructions as may be required to practice embodiments of the disclosure.

The shown computing platform 606 is interconnected to the Internet 648 through one or more network interface ports (e.g., network interface port 623₁ and network interface port 623₂). The configuration 601 can be addressed through one or more network interface ports using an IP address. Any operational element within computing platform 606 can perform sending and receiving operations using any of a range of network protocols, possibly including network protocols that send and receive packets (e.g., network protocol packet 621₁ and network protocol packet 621₂).

The computing platform 606 may transmit and receive messages that can be composed of configuration data, and/or any other forms of data and/or instructions organized into a data structure (e.g., communications packets). In some cases, the data structure includes program code instructions (e.g., application code) communicated through the Internet 648 and/or through any one or more instances of communications link 615. Received program code may be processed and/or executed by a CPU as it is received and/or program code may be stored in any volatile or non-volatile storage for later execution. Program code can be transmitted via an upload (e.g., an upload from an access device over the Internet 648 to computing platform 606). Further, program code and/or results of executing program code can be delivered to a particular user via a download (e.g., a download from the computing platform 606 over the Internet 648 to an access device).

The configuration 601 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A cluster is often embodied as a collection of computing nodes that can communicate between each other through a local area network (e.g., LAN or VLAN) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provision of power to the other units. In some cases, a unit in a rack is dedicated to environmental conditioning functions such as filtering and movement of air through the rack, and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Further details regarding general approaches to managing data repositories are described in U.S. Pat. No. 8,601,473 titled, “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled, “METHOD AND SYSTEM FOR IMPLEMENTING MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 6B illustrates a virtualized controller implemented by a containerized architecture in which some embodiments are implemented. FIG. 6B depicts a virtualized controller implemented by a containerized architecture 6B00. The containerized architecture comprises a collection of interconnected components suitable for implementing embodiments of the present disclosure and/or for use in the herein-described environments. Moreover, the shown containerized architecture 6B00 includes a container instance in a configuration 651 that is further described as pertaining to the container instance 650. The configuration 651 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any container (e.g., container instance 650). A container instance can be executed by a processor. Runnable portions of a container instance sometimes derive from a container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container instance (e.g., a Docker container) can serve as an instance of an application container. Any container of any sort can be rooted in a directory system, and can be configured to be accessed by file system commands (e.g., “ls” or “ls-a”, etc.). The container might optionally include operating system components 678, however such a separate set of operating system components need not be provided. As an alternative, a container can include a runnable instance 658, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 676. Such a container virtual disk controller can perform any of the functions that the aforementioned CVM virtual disk controller 626 can perform, yet such a container virtual disk controller does not rely on a hypervisor or any particular operating system so as to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

Embodiments as disclosed herein may be implemented in both the virtual machine architecture 6A00 or the containerized architecture 6B00. For example, a local sizing module 151 may reside within one or many nodes of a virtual machine architecture or containerized architecture, with data collection occurring across the nodes of a virtual machine architecture or containerized architecture using node level instances of a data collection module. Furthermore, the nodes of a virtual machine architecture or containerized architecture may be used to preprocess and/or combine data collected locally prior to transmission to the global sizing system. Furthermore, the global sizing system may also comprise a collection of nodes of a virtual machine architecture or containerized architecture where the initial sizing module 112, the analysis module 111, the feedback management module 144, and the database 130 are constructed of the nodes of a virtual machine architecture or containerized architecture. Using similar techniques to those used by the remote system 150a-n the global sizing system may distribute the necessary work for initial sizing and analysis across the nodes of the global sizing system such as by used multiple instances of each module and assigning work to different nodes of the system. In some embodiments, the data collection mechanisms and the local sizing modules may be implemented in the virtualized controllers of the remotes systems. Finally, because the processes/modules may be distributed across the systems, the disclosed processes may be executed in parallel. Furthermore, any combination of the feedback management module 144, analysis module 111, initial sizing module 112, and the local sizing module 151 may be contained within a Controller/Service VM such as Controller/Service VM 610a-b discussed below in regard to FIGS. 6A-B.

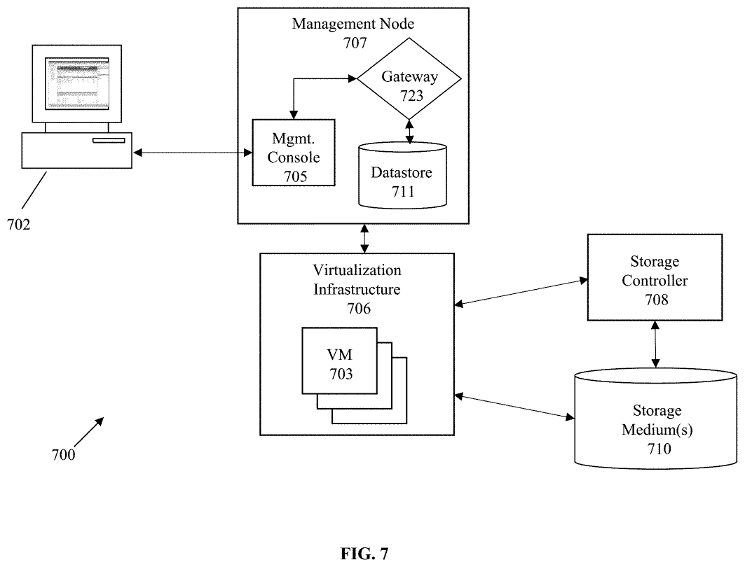

FIG. 7 illustrates a system 700 to implement a virtualization management console 705 according to some embodiments of the invention. In some embodiments, the method and apparatus for closed-loop and dynamic capacity management in a web-scale data center may operate on a virtualization management console, such as via a management console or on/within a cluster itself and accessed through the management console. The cluster may execute processes for a local sizing module and data collection processes and the virtualization management console may control the transmission and analysis of the results.

The system 700 includes one or more users at one or more user stations 702 that use the system 700 to operate the virtualization system 700 and/or management console 705. The user station 702 comprises any type of computing station that may be used to operate or interface with the system 700. Examples of such user stations include workstations, personal computers, or remote computing terminals. The user station 702 comprises a display device, such as a display monitor, for displaying a user interface to users at the user station. The user station 702 also comprises one or more input devices for the user to provide operational control over the activities of the system 700, such as a mouse or keyboard to manipulate a pointing object in a graphical user interface.

System 700 includes virtualization infrastructure 706, comprising any processing components necessary to implement and provision one or more VMs 703. This may include management components to obtain status for, configuring, and/or controlling the operation of one or more storage controllers and/or storage mediums 710. Data for the VMs 703 are stored in a tangible computer readable storage device 710. The computer readable storage device 710 comprises any combination of hardware and software that allows for ready access to the data that is located at the computer readable storage device 710. The storage controller 708 is used to manage the access and operation of the computer readable storage device 710. While the storage controller is shown as a separate component here, it is noted that any suitable storage controller configuration may be employed. For example, in some embodiments, the storage controller can be implemented as a virtual machine as described in more detail below. As noted in more detail below, the virtualization infrastructure 706 may correspond to a cluster of multiple nodes that are integrated as a single system.

System 700 includes a management console 705. The management console 705 provides an interface that permits a user to manage and administer the operation of the system. According to some embodiments, the management console 705 comprises a JavaScript program that is executed to display a management user interface within a web browser at the user station 702. In some embodiment, the storage controller exposes an API or GUI to create, read, update, delete (CRUD) data stores at the computer readable medium 710, which can be managed by the management console 705.

In some embodiments, a web browser at the user station 702 is used to display a web-based user interface for the management console. The management console 705 corresponds to JavaScript code to implement the user interface. Metadata regarding the system 700 is maintained at a datastore 711, which collects data relating to the virtualization infrastructure 706, the storage mediums 710, and/or datastores at the storage mediums. The JavaScript code interacts with a gateway 723 to obtain the metadata to be displayed in the user interface. In some embodiments, the gateway comprises a web server and servlet container, e.g., implemented using Apache Tomcat. Further details regarding methods and mechanisms for implementing virtualization management console illustrated in FIG. 7 are described in U.S. Provisional Patent Application No. 62/108,515, filed Jan. 27, 2015, which is hereby incorporated by reference in its entirety.

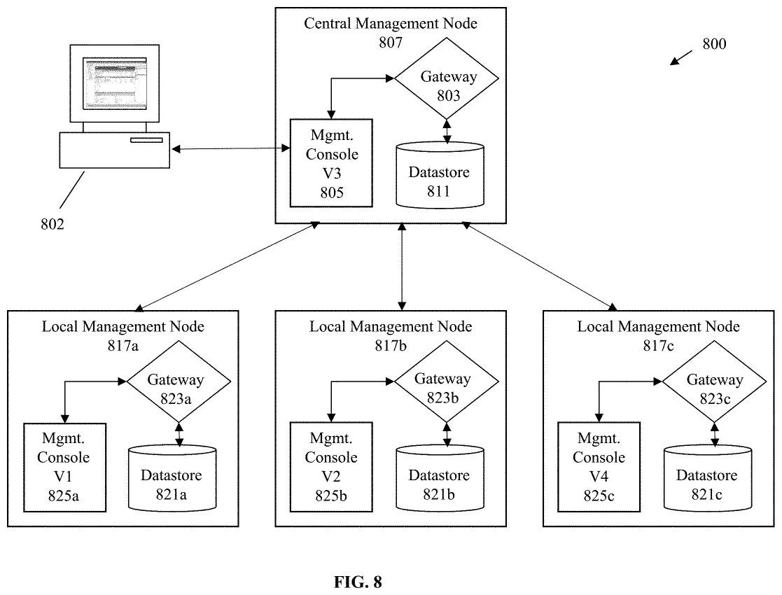

FIG. 8 illustrates a larger computing environment having multiple underlying systems/clusters to be managed, where a separate management node may also exist for each of the underlying systems/clusters.

In some embodiments, the method and apparatus for closed-loop and dynamic capacity management in a web-scale data center may operate on a virtualization management console, such as via a central management node or on/within a cluster itself and accessed through the central management console. Further, information for and about one or more clusters may be used as relevant data for the operations described herein. For instance, a local sizing module on a management console may determine that the cluster is over provisioned, and a sizing module for another cluster may determine that the other cluster is under provisioned. Recommendations based on these determinations might include migration of resources from one cluster to the other or swapping one node or component on one system with that of another. The swapped nodes or components may increase one capability while decreasing another, such as when one cluster is processor bound and another cluster is storage bound and shifting components rebalances both clusters advantageously. Furthermore, individual clusters may execute their own local sizing module and data collection processes and the central management node may control the transmission and analysis of the results with respect to each console.

The method and apparatus for closed-loop and dynamic capacity management in a web-scale data center may be operated through system 800 which includes a central management node 807 that includes its own management console JavaScript code 805, for gateway 803, and datastore 811 and is capable of implementing the control of multiple underlying systems managed by local management consoles, e.g. local management nodes 817a-c. The local management consoles 825a-c are equivalent to the management console 705 except to the extent that they correspond to different clusters. Similarly, gateways 823a-c, datastore 821a-c, and local management node 817a-c correspond to gateway 723, datastore 711, and to management node 707, excluding that each of the local management nodes 817a-c may correspond to different underling virtualization infrastructures, e.g. virtualization infrastructures. Furthermore, system 800 may be interfaced with via a user stations 802 which may be equivalent to that discussed above regarding user station 702. Finally, further details regarding methods and mechanisms for implementing virtualization management console illustrated in FIG. 8 are described in U.S. Provisional Patent Application No. 62/108,515, filed Jan. 27, 2015, which is hereby incorporated by reference in its entirety.

### System Architecture

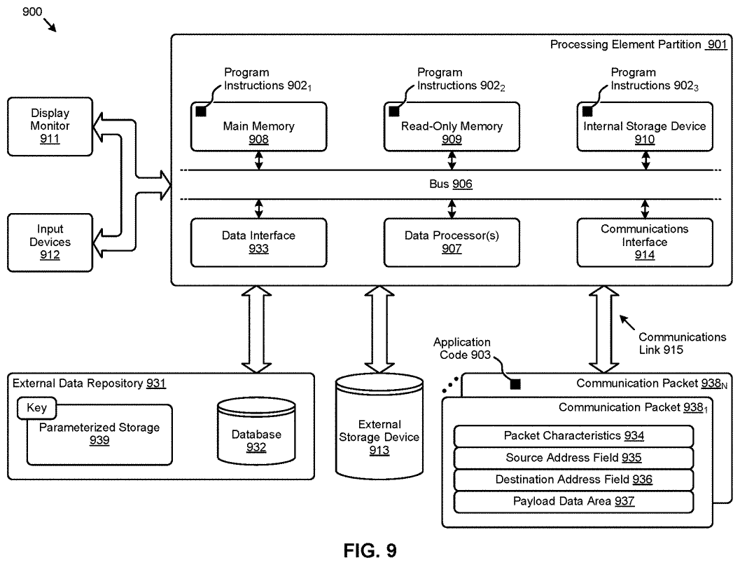

FIG. 9 depicts a block diagram of an instance of a computer system 900 suitable for implementing embodiments of the present disclosure. Computer system 900 includes a bus 906 or other communication mechanism for communicating information. The bus interconnects subsystems and devices such as a CPU, or a multi-core CPU (e.g., data processor 907), a system memory (e.g., main memory 908, or an area of random access memory (RAM)), a non-volatile storage device or non-volatile storage area (e.g., read-only memory 909), an internal storage device 910 or external storage device 913 (e.g., magnetic or optical), a data interface 933, a communications interface 914 (e.g., PHY, MAC, Ethernet interface, modem, etc.). The aforementioned components are shown within processing element partition 901, however other partitions are possible. The shown computer system 900 further comprises a display 911 (e.g., CRT or LCD), various input devices 912 (e.g., keyboard, cursor control), and an external data repository 931.

According to an embodiment of the disclosure, computer system 900 performs specific operations by data processor 907 executing one or more sequences of one or more program code instructions contained in a memory. Such instructions (e.g., program instructions 902₁, program instructions 902₂, program instructions 902₃, etc.) can be contained in or can be read into a storage location or memory from any computer readable/usable medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 900 performs specific networking operations using one or more instances of communications interface 914. Instances of the communications interface 914 may comprise one or more networking ports that are configurable (e.g., pertaining to speed, protocol, physical layer characteristics, media access characteristics, etc.) and any particular instance of the communications interface 914 or port thereto can be configured differently from any other particular instance. Portions of a communication protocol can be carried out in whole or in part by any instance of the communications interface 914, and data (e.g., packets, data structures, bit fields, etc.) can be positioned in storage locations within communications interface 914, or within system memory, and such data can be accessed (e.g., using random access addressing, or using direct memory access DMA, etc.) by devices such as data processor 907.

The communications link 915 can be configured to transmit (e.g., send, receive, signal, etc.) any types of communications packets (e.g., communications packet 938₁, communications packet 938_{N}) comprising any organization of data items. The data items can comprise a payload data area 937, a destination address 936 (e.g., a destination IP address), a source address 935 (e.g., a source IP address), and can include various encodings or formatting of bit fields to populate the shown packet characteristics 934. In some cases, the packet characteristics include a version identifier, a packet or payload length, a traffic class, a flow label, etc. In some cases, the payload data area 937 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 907 for execution. Such a medium may take many forms including, but not limited to, non-volatile media and volatile media. Non-volatile media includes, for example, optical or magnetic disks such as disk drives or tape drives. Volatile media includes dynamic memory such as a random access memory.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 931, which in turn can be formatted into any one or more storage areas, and which can comprise parameterized storage 939 accessible by a key (e.g., filename, table name, block address, offset address, etc.).

Execution of the sequences of instructions to practice certain embodiments of the disclosure are performed by a single instance of the computer system 900. According to certain embodiments of the disclosure, two or more instances of computer system 900 coupled by a communications link 915 (e.g., LAN, PTSN, or wireless network) may perform the sequence of instructions required to practice embodiments of the disclosure using two or more instances of components of computer system 900.

The computer system 900 may transmit and receive messages such as data and/or instructions organized into a data structure (e.g., communications packets). The data structure can include program instructions (e.g., application code 903), communicated through communications link 915 and communications interface 914. Received program code may be executed by data processor 907 as it is received and/or stored in the shown storage device or in or upon any other non-volatile storage for later execution. Computer system 900 may communicate through a data interface 933 to a database 932 on an external data repository 931. Data items in a database can be accessed using a primary key (e.g., a relational database primary key).

The processing element partition 901 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 907. Some embodiments include one or more special-purpose hardware components (e.g., power control, logic, sensors, transducers, etc.).

Various implementations of the database 932 comprise storage media organized to hold a series of records or files such that individual records or files are accessed using a name or key (e.g., a primary key or a combination of keys and/or query clauses). Such files or records can be organized into one or more data structures Such files or records can be brought into and/or stored in volatile or non-volatile memory.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer-implemented method, comprising:
maintaining a sizing parameter at a first system, comprising:
collecting system usage information and system configuration information from a plurality of remote systems,
analyzing the system usage information and the system configuration information from the plurality of remote systems, and
updating the sizing parameter based on at least the system usage information and the system configuration information from the plurality of remote systems, the sizing parameter corresponding to a system configuration rule and to a system function, wherein analysis is locally performed at a remote system of the plurality of remote system by a sizing module local to the remote system to generate a recommended configuration change that is based on at least analysis of the system usage information and the system configuration information from the plurality of remote systems; and
transmitting the sizing parameter to the sizing module local to the remote system of the plurality of remote systems.

2. The method of claim 1, wherein system usage information comprises at least usage or utilization data for one or more computing resources including at least storage, processing, or communications bandwidth.

3. The method of claim 1, wherein system configuration information comprises at least information pertaining to hardware or software components and the hardware or software components arrangement and configuration.

4. The method of claim 1, wherein collecting system usage information and system configuration information from the plurality of remote systems comprises at least associating the system usage information and the system configuration information with previously stored system usage information or previously stored system configuration information.

5. The method of claim 1, wherein analyzing the system usage information and the system configuration information from the plurality of remote systems is predicated on one or more conditions for analysis comprising at least one of a minimum amount of time since elapsed since a previously performed of data analysis, a maximum amount of time since a previously performed data analysis, or a determination that additional system usage information has been received at the first system.

6. The method of claim 1, wherein additional system usage information and additional system configuration information is received periodically from at least some of the plurality of remote systems.

7. The method of claim 1, wherein analyzing the system usage information and the system configuration information from the plurality of remote systems comprises at least generating aggregate data on a per user, system, function, resource, or component basis.

8. A non-transitory computer readable medium having stored thereon a sequence of instructions which, when executed by a processor performs a set of acts comprising:
maintaining a sizing parameter at a first system by:
collecting system usage information and system configuration information from a plurality of remote systems,
analyzing the system usage information and the system configuration information from the plurality of remote systems, and
updating the sizing parameter based on at least the system usage information and the system configuration information from the plurality of remote systems, the sizing parameter corresponding to a system configuration rule and to a system function, wherein analysis is locally performed at a remote system of the plurality of remote system by a sizing module local to the remote system to generate a recommended configuration change that is based on at least analysis of the system usage information and the system configuration information from the plurality of remote systems; and
transmitting sizing parameter to the sizing module local to the remote system of the plurality of remote systems.

9. The computer program product of claim 8, wherein system usage information comprises at least usage or utilization data for one or more computing resources including at least storage, processing, or communications bandwidth.

10. The computer program product of claim 8, wherein system configuration information comprises at least information pertaining to hardware or software components and the hardware or software components arrangement and configuration.

11. The computer program product of claim 8, wherein collecting system usage information and system configuration information from the plurality of remote systems comprises at least associating the system usage information and the system configuration information with previously stored system usage information or previously stored system configuration information.

12. The computer program product of claim 8, wherein analyzing the system usage information and the system configuration information from the plurality of remote systems is predicated on one or more conditions for analysis comprising at least one of a minimum amount of time since elapsed since a previously performed of data analysis, a maximum amount of time since a previously performed data analysis, or a determination that additional system usage information has been received at the first system.

13. The computer program product of claim 8, wherein additional system usage information and additional system configuration information is received periodically from at least some of the plurality of remote systems.

14. The computer program product of claim 8, wherein analyzing the system usage information and the system configuration information from the plurality of remote systems comprises at least generating aggregate data on a per user, system, function, resource, or component basis.

15. A computer system for dynamic capacity management, comprising:
a memory for storing data and instructions; and
a processor that executes the instructions to enable actions, including:
maintaining a sizing parameter at a first system by:
collecting system usage information and system configuration information from a plurality of remote systems,
analyzing the system usage information and the system configuration information from the plurality of remote systems, and
updating the sizing parameter based on at least the system usage information and the system configuration information from the plurality of remote systems, the sizing parameter corresponding to a system configuration rule and to a system function, wherein analysis is locally performed at a remote system of the plurality of remote system by a sizing module local to the remote system to generate a recommended configuration change that is based on at least analysis of the system usage information and the system configuration information from the plurality of remote systems; and
transmitting the sizing parameter to the sizing module local to the remote system of the plurality of remote systems.

16. The computer system of claim 15, wherein system usage information comprises at least usage or utilization data for one or more computing resources including at least storage, processing, or communications bandwidth.

17. The computer system of claim 15, wherein system configuration information comprises at least information pertaining to hardware or software components and the hardware or software components arrangement and configuration.

18. The computer system of claim 15, wherein collecting system usage information and system configuration information from the plurality of remote systems comprises at least associating the system usage information and the system configuration information with previously stored system usage information or previously stored system configuration information.

19. The computer system of claim 15, wherein analyzing the system usage information and the system configuration information from the plurality of remote systems is predicated on one or more conditions for analysis comprising at least one of a minimum amount of time since elapsed since a previously performed of data analysis, a maximum amount of time since a previously performed data analysis, or a determination that additional system usage information has been received at the first system.

20. The computer system of claim 15, wherein additional system usage information and additional system configuration information is received periodically from at least some of the plurality of remote systems.

21. The computer system of claim 15, wherein analyzing the system usage information and the system configuration information from the plurality of remote systems comprises at least generating aggregate data on a per user, system, function, resource, or component basis.
